(19) United States
(12) Patent Application Publication
(10) Pub. No.: US 2015/0088919 A1
(43) Pub. Date: Mar. 26, 2015

(54) TRANSFORMING A QUERY TO REUSE STORED DATA

(71) Applicant: Oracle International Corporation, Redwood Shores, CA (US)

(72) Inventors: James HUNTER, Redwood Shores, CA (US); Adam KOCIUBES, Redwood Shores, CA (US); Ekrem S.C. SOYLEMEZ, Redwood Shores, CA (US)

(21) Appl. No.: 14/033,358

(22) Filed: Sep. 20, 2013

(51) Int. Cl. G06F 17/30

(52) U.S. Cl. CPC G06F 17/30451
USPC 707/759

(57) ABSTRACT

Methods, computer systems, and stored instructions are described herein for transforming a query or execution plan to re-use stored data. A query processor stores a query or a representation thereof. Before executing the query, the query processor analyzes the query or representation to determine whether the query or representation could cause at least part of a data structure to be generated at least twice. Based at least in part on determining that the at least part of the data structure could be generated at least twice by the query or representation, the query processor transforms the query or representation. The transformed query or representation includes a first transformed sub-query or sub-operation that generates and stores the at least part of the data structure, and a second transformed sub-query or sub-operation uses the at least part of the data structure that was stored by the first transformed sub-query or sub-operation.

### CROSS-REFERENCE TO RELATED APPLICATIONS

The present application is related to U.S. patent applications having attorney docket numbers 50277-4423, 50277-4424, and 50277-4426, filed on even date herewith, the entire contents of which are incorporated by reference as if fully set forth herein.

### TECHNICAL FIELD

The technical field relates to query transformation and re-use of stored data.

### BACKGROUND

### Storing Data

Database systems are often designed to maintain huge amounts of information about a variety of entities, events, or occurrences (referred to generally as occurrences), and these occurrences may be described by a variety of characteristics. Even database systems that do not yet contain huge amounts of information are often designed to be scalable such that the database systems can be adapted to accommodate huge amounts of information. Huge tables, which may include every occurrence and every characteristic of every occurrence, may be impossible to analyze if there are not enough resources to store and process significant portions of these tables. Even if sufficient resources are available, storing and processing significant portions of these huge tables can be quite costly. As a result, when occurrences have many characteristics or are otherwise related to a variety of information, many database systems separate such information about the occurrences into multiple tables.

Database systems often group tables based on categories of characteristics. Much of the information may be descriptive information about entities, categories, or classes of information (referred to generally as categories) involved in the occurrences. The description of these underlying categories may change infrequently compared to the other tables that record or measure the occurrences themselves. Dimension tables are tables that contain descriptive information about occurrences that are referenced by or may be referenced by other table(s). The other table(s) include column(s) that reference row(s) of the dimension table(s), and each referencing column is referred to herein as a dimension. Data that is organized into two or more dimensions is referred to herein as multidimensional data.

Fact tables are the other tables that measure the occurrences related to the categories. In other words, fact tables store facts or measurable quantitative data, and this measurable data may be involved with or otherwise fall under the categories. By referencing the dimension tables, the fact tables do not need to duplicate all of the information contained in the dimension tables. Generally, because fact tables may include multiple occurrence(s) that reference the same category, fact tables are usually larger than dimension tables. Also, because fact tables measure the occurrences rather than recording the definitions, the fact tables are usually updated more frequently than dimension tables. An organization of multidimensional data into fact table(s) and dimension table(s) is referred to as a star schema.

In various examples, dimensions may range from five, to tens of thousands, to millions of rows, and the fact table could be from millions to billions of rows.

In one example, a product may be defined and described in one table, and that product as well as other products may appear in sales records of a sales table. Customers may also be described in one table and referenced in the sales table. The sales records in the sales tables may correspond to occurrences of sales by a business, and, in particular, may identify which products and customers were involved in the respective sales. The sales records might not provide much if any other description of the products or customers that were involved in the respective sales. Instead, the sales records may refer to the customers and products tables using keys.

Data may be stored in a variety of manners in a variety of database objects, and the stored data may be retrieved from storage using structured requests. Data stored in relational database systems (“ROLAP” systems), for example, according to a star schema, is accessible to all applications that support interaction with such relational systems. Such database applications communicate with the relational database system by submitting commands that conform to the database language supported by the relational database system, the most common of which is the Structured Query Language (SQL). However, relational queries are not designed to handle multidimensional data because relational queries join two tables at a time using local join operations.

### Query Execution and Optimization

A query is an expression, command, or set of commands that, when executed, causes a server to perform an operation on a set of data. A query may be processed in a predictable order by query processors. For example, the order of precedence may be FROM, WHERE, GROUP BY, HAVING, SELECT, and ORDER BY. A query processor may vary the order if varying the order is predicted to be more efficient, as long as varying the order would not change a result of the query. In other words, the order of precedence in the query does not guarantee any particular order of operations when the query is executed, as long as the query, as executed, produces the result that would have been produced if the order of operations had been preserved.

In query optimization, a query optimizer or other query processor may transform queries or parts thereof (“sub-queries”) from one form to another form as long as the queries and the transformed queries are semantically equivalent to each other. As used herein, a query is “transformed” when the query is (a) rewritten from a first form to a second form, (b) received in a manner that specifies a first set of operations, such as a first form or a first execution plan, and executed or planned for execution using a second set of operations, such as the operations specified by a second form or second execution plan. An execution plan is a set of directives, such as a query tree structure, that is prepared for an execution engine. Two queries or execution plans are semantically equivalent to each other when the two queries or execution plans, if executed, would produce equivalent result sets, even if the result sets are assembled in different manners by the two queries or execution plans. Execution of a query is semantically equivalent to a query or execution plan if the query execution produces a result set that is equivalent to the one that would be produced by the query or execution plan, if executed.

To speed up query evaluation, a query may be executed using indices, materialized views, or solved cubes that are built using data from the dimension tables and the fact table. Unfortunately, these methods of executing queries have significant drawbacks. Specifically, building indexes, materialized views, or solved cubes for each possible combination of fact table columns may be cost prohibitive, especially when there are many dimensions and the fact table contains numerous foreign key columns. If indexes or materialized views are not built for all combinations of columns, then an index or materialized view built on the exact columns of the fact table that are constrained by any given query may not exist.

Additionally, indexes or materialized views built on a superset of the columns constrained by a query are not always helpful. For example, an index built on key1, key2, key3 is useless for a query that does not specify a constraint for key1. Use of indexes built on a subset of the columns constrained by a query may not be efficient either. Since each constraint alone may not significantly constrain the query, conventional join techniques typically require scanning a large portion of the fact table when only a very small number of the rows in the fact table actually satisfy all of the constraints of the query.

A server may execute queries to perform complex operations on stored data, and the server may cache, in a results cache, full or partial results for queries as the results are generated. When the server begins computing a new set of results, the server may check the results cache to see if any of the results have already been stored in the results cache. The server does not find any such results if such results have not yet been computed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates an example server-client system for analyzing queries, transforming queries to re-use stored data, and executing the transformed queries against a database.

FIG. 2 illustrates an example process for transforming a query to re-use stored data.

FIG. 3 illustrates an example computer system that may be specially configured according to the various embodiments described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods, computer systems, and stored instructions are described herein for transforming a query or execution plan to re-use stored data. A query processor receives a query, such as a SQL query, or a representation thereof, such as an execution plan. The received query or a transformation thereof may be stored temporarily for processing. Before executing the stored query, the query processor analyzes the query or representation to determine whether the query or representation, if executed, could cause at least part of a data structure to be generated at least twice. Based at least in part on determining that the at least part of the data structure could be generated at least twice by the query or representation, the query processor transforms the query or representation. The transformed query or representation includes a first transformed sub-query or sub-operation that, if executed, generates and stores the at least part of the data structure, and at least a second transformed sub-query or sub-operation that, if executed, uses the at least part of the data structure that was stored by the first transformed sub-query or sub-operation.

The query processor determines that the query or representation “could” cause at least part of the data structure to be generated at least twice at least in part by determining multiple candidate transformations for the query or representation. At least one of the candidate transformations, if executed, would cause at least part of the data structure to be generated at least twice. Upon detecting this candidate transformation, the query processor may modify the query or representation to cause the at least part of the data structure to be saved and re-used rather than being generated at least twice.

The received query may include two or more sub-queries, each of which, if executed, could cause the data structure to be generated. For example, the received query may include a first sub-query and a second sub-query. The query processor may transform this query into a transformed query that includes at least a first transformed sub-query and a second transformed sub-query. The first transformed sub-query may be added in addition to the first sub-query or may replace the first sub-query. If the first transformed sub-query is added in addition to the first sub-query and the second sub-query, then each of the first sub-query and the second sub-query may further be transformed to reference the first transformed sub-query. In other words, in the example, the transformed query would include at least three sub-queries: one that creates and stores the data structure and two that reference and use the stored data structure. The transformed sub-queries that reference the created data structure may be made dependent on or in a child query block of the transformed sub-query that creates the data structure.

If the first transformed sub-query replaces the first sub-query of the received query, then the second sub-query of the received query may be further transformed to reference the first transformed sub-query. In this example, the transformed query includes at least two sub-queries: one that creates, uses, and stores the data structure and one that references and uses the stored data structure.

The query processor may include machine components, such as a computer system operating a standalone optimizer or an optimizer that is integrated with a server. The query processor may include stored instructions, such as optimizer instructions or integrated optimizer and server instructions, that specially configure a machine to process queries. The query processor operates to implement a process, such as an optimizer or an integrated optimizer and server process, that operates on a machine, such as the server.

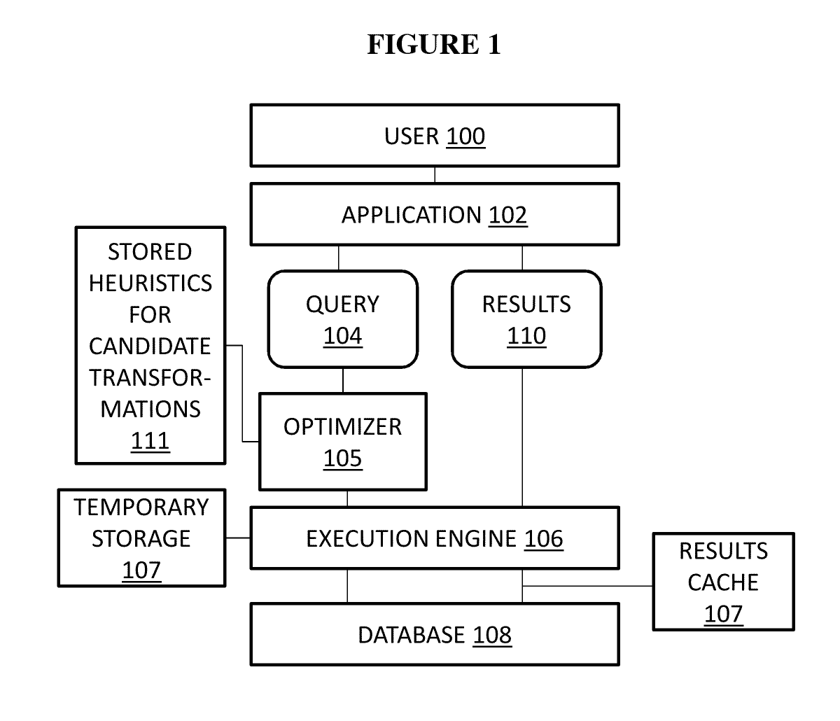

FIG. 1 illustrates an example server-client system for analyzing queries, transforming queries to re-use stored data, and executing the transformed queries against a database. As shown, user 100 interacts with application 102 to send a query 104 to optimizer 105. Optimizer 105 may be separate from execution engine 106 as shown. Alternatively, Optimizer 105 and execution engine 106 may operate on same or different devices and may have a high amount or low amount of integration with each other. Optimizer accesses stored heuristics for candidate transformations 111 to determine which candidate transformations are available for query 104. Optimizer transforms the query or generates an execution plan using one or more of the candidate transformations to generate one or more candidate queries or execution plans. A costing mechanism built into optimizer 105 selects one of the candidate queries or execution plans to send to execution engine 106 for execution.

In the example, the selected candidate query may be one that instructs execution engine 106 to create and re-use a temporary structure during execution of query 104. Execution engine 106 may create and retain the temporary structure in temporary storage 107, and the temporary structure may be used and re-used for multiple parts of query 104. Execution engine 106 completes execution of the transformed query or execution plan against database 108 and returns results 110 to application 102. Execution engine 106 may also cause results 110 to be saved to a results cache 107. The results that remain in results cache 107 may be re-used by execution engine during execution of future queries. In one example, results cache 107 is maintained as a circular buffer such that older items expire and are overwritten by newer items.

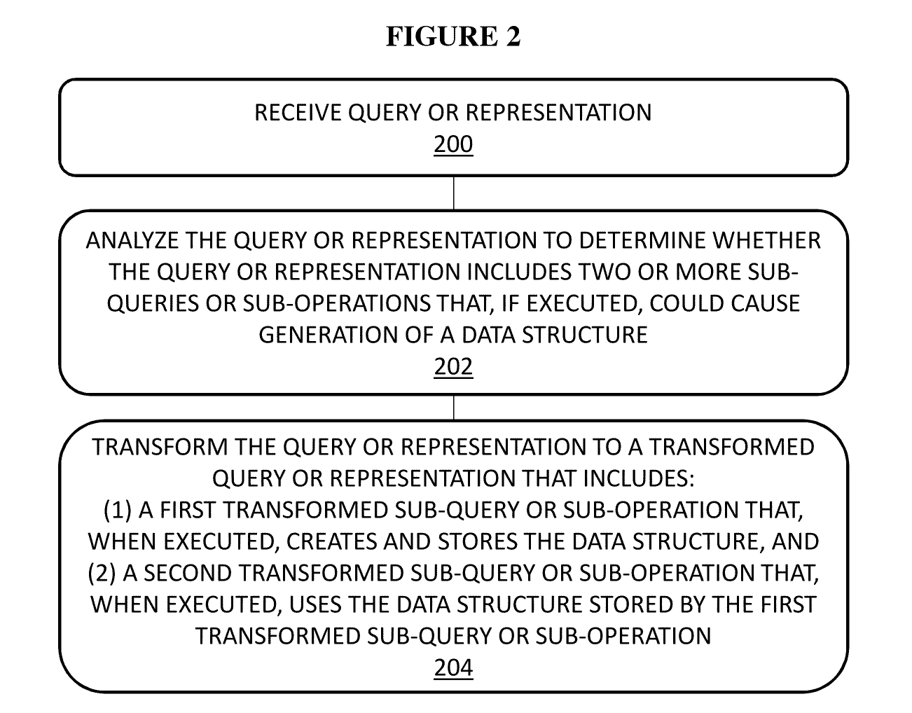

FIG. 2 illustrates an example process for transforming a query to re-use stored data. As shown, in step 200, a query processor such as an optimizer receives a query or representation. The query processor then analyzes the query or representation in step 202 to determine whether the query or representation includes two or more sub-queries or sub-operations that, if executed, could cause generation of a data structure. For example, the query processor may identify one or more candidate transformations that utilize such a data structure to complete a complex operation. In step 204, the query processor transforms the query or representation to a transformed query or representation that includes: (1) a first transformed sub-query or sub-operation that, when executed, creates and stores the data structure, and (2) a second transformed sub-query or sub-operation that, when executed, uses the data structure stored by the first transformed sub-query or sub-operation.

### Pre-Execution Determination

Unlike caching mechanisms, the query processor determines to re-use data that is to be generated and stored by multiple sub-queries before any of those sub-queries are executed. In other words, the data to be re-used does not yet exist when the query processor makes this determination. The query processor instead analyzes the sub-queries and the data that could be created and used to execute the sub-queries. In this analysis, the query processor may consider multiple alternative queries or plans that could be used to achieve the same result as the received query.

The determination to re-use data may be made at compile time as the query processor is rewriting the query and/or selecting an execution plan to carry out the query operations. In this manner, the query processor looks ahead to sub-queries that have yet to be executed to predict that at least some semantically equivalent representation or transformation of those queries, when executed, would use at least some overlapping data. Instead of allowing the queries to be executed as-is, the query processor rewrites the query or selects a transformed execution plan that ensures that the overlapping data is stored by a sub-query and re-used by at least one of the sub-queries.

Because the transformation is done at compile time, the query processor may also place ordering restraints on the query to ensure that, during execution, the portion of the query that creates a data structure is executed before the portion of the query that uses the created data structure. In one embodiment, this is accomplished by moving the portion of the query that creates the data structure to a parent query block of the sub-query or sub-queries that use the data structure. In another embodiment, this is accomplished by marking the query or representation to indicate that one portion depends on the other portion. In one example, a sub-query that calculates a result set is marked using a WITH clause that causes the result set to be saved for use by another sub-query. The query as received might not have contained any WITH clauses before the sub-query is marked.

In one embodiment, a first transformed sub-query or sub-operation, when executed, causes the at least part of the data structure to be stored separately from a results cache that is used during execution to cache results for the query. The data structure may be retained in storage until after the at least part of the data structure has been used for other transformed sub-queries. For example, a structure that densely defines a dimension of data or holds aggregated data may be saved separately from the results cache and in a manner specified by the transformed query or representation.

In one embodiment, although the query processor makes a determination at compile time, the query processor stores the data structure into the results cache. The results cache normally holds results that have already been calculated. In this embodiment, the query processor instructs the execution engine to write a data structure to the results cache before the query has been executed, and to keep the written data structure in the results cache until the sub-queries or sub-operations that reference the data structure have been executed.

Alternatively, the query processor may write to a temporary table. For example, the query processor may use a linearized execution row source to populate the temporary table. The linearized execution row source may be initiated based on a WITH clause that is inserted into the query or based on some other marking in the query.

### Re-Use of Unreferenced Support Structure

In one embodiment, the overlapping data is not referenced by the received query or any representation thereof. Instead, the query processor analyzes the query to determine several available candidate transformations or transformed plans for executing a semantically equivalent query. At least one of these plans may cause the creation and use of the at least part of the data structure for the first sub-query and the second sub-query, even if neither sub-query initially referenced the data structure or any part thereof. For example, the data structure may be an unreferenced support structure that may be used by the server to complete a complex operation. Upon detecting that a candidate query or plan, if executed, would duplicate effort in creating the at least part of the data structure, the query processor modifies the query or plan to save the at least part of the data structure upon a first instance of creating the at least part of the data structure. The saved data may then be re-used for a second instance that would have otherwise created the data.

In various embodiments, a received query may be formulated to identify at least one result set that is to be re-used. For example, the user may place mark a sub-query using a WITH clause and a name, and then the user may reference the name later in the query. Upon execution of the query, the server may store the result of the sub-query in a temporary table and then read from the temporary table whenever the name is referenced. According to techniques described herein, the query may be rewritten to re-use a data structure that is not referenced in the query using a WITH clause, a view, or any other manner of marking a sub-query. The query as received may have been formulated to generate at least part of the data structure two or more times, and the query is transformed such that the data structure is generated once and re-used one or more times.

In one embodiment, the query processor analyzes the query or representation to find isomorphic query blocks, which are query blocks that, if executed, would generate at least part of the same data structure. Upon finding two or more isomorphic query blocks representing sub-queries, the query processor removes them and adds a new query block to a parent of the isomorphic query blocks. Adding the query block to the parent ensures that the query block is available before the sub-queries are executed. The query processor then adjusts references for the isomorphic query blocks so that the isomorphic query blocks point to the new query block.

In another embodiment, the query processor adds a first marking, such as a WITH clause, to a first isomorphic query block to indicate that results of the first isomorphic query block should be saved. The query processor also adds a second marking to a second isomorphic query block. The second marking references a name specified by the first marking to indicate that the second block should use the results that were calculated by the first block.

Various examples refer to one sub-query or sub-operation referencing a data structure created by another sub-query or sub-operation. The data structure may be referenced by assigning a name to the data structure in a first sub-query or sub-operation and then using the name in another sub-query or sub-operation. Alternatively, a location of the data structure may be assigned by a first sub-query or sub-operation, and the location may be used in another sub-query or sub-operation to retrieve the data structure. The name or location may be a default name or location for re-usable data structures or may be a name or location that is specified in the earlier sub-query or sub-operation.

In another embodiment, a query has multiple query blocks that include joins to the same, unfiltered table. The query might not have any sub-queries that are repeated, but the query may still be marked to re-use data structures. In the example, the query is marked to save and re-use interim temporary data structures, such as hash tables and data structures based on dense set identifiers. In this embodiment, the query is transformed to add a query block to calculate the interim data structure(s). The query block is added to query blocks that, if executed, would use the data structures. For example, query blocks that use a same dimension for a different join operation may re-use a data structure that densely describes a range of values for that dimension. The re-used data structure might not be the result of any query block, but the re-used data structure might nonetheless be used as an interim structure for computing different query blocks.

In one example, the non-referenced data structure may be a data structure that is generated to support alternative plans for executing complex operations. For example, a data structure may be created to support processing of dimensional data or to support aggregation operations. The data structure to support processing of dimensional data may store dense set identifiers that identify different combinations of values that occur in dimension(s) that are referenced in the query. The dense set identifiers may be used to create storage containers to hold aggregated data from the fact table that satisfies the different combinations of values that are represented by the dense set identifiers. Different ones of the storage containers may be mapped to different combinations of data values such that data may be accumulated in the storage containers as the aggregation operation is performed. Upon completion of the aggregation operation, the data structure may store a computed aggregation for a set of data. If any of these data structures are saved, the saved data structures may be used for other computations that account for or use the computed dimensional data or the computed aggregation for the set of data, or even for other operations that would use the storage containers or dense set identifiers for other purposes.

The data structure may be optimized for a particular set of data. For example, a query may reference dimensional data and fact data, and the data structure may be created to represent, for each dimension of the dimensional data, unique combinations of values in the dimension. The data structure may be compressed such that there are few or no holes in the data structure. In other words, even if there are holes in the range of unique combinations of values, the data structure may be defined to have a continuous range of representative values. The representative values are called set identifiers because they identify sets of values that occur in a dimension, and the dimension may include one, two, or more columns. In a particular example, the range of the data structure is consecutive integers that represent each combination of values that actually occurs in the dimension. The range of the data structure may exclude combinations of values that would be possible if different columns of the dimension were independent, but that do not actually occur in the different columns of the dimensions. For example, the region, “California,” may always appear with the country, “USA,” and the data structure would not need to represent the possibility of “California” appearing in combination with other country values.

In one embodiment, the data structure may or may not be referenced in the query received from the application or user or in any stored representation thereof until the query is transformed to add a reference to the data structure and/or transformed to re-use the data structure. For example, the query processor may receive Query 2 below:

QUERY 2

select sum(s.amount_sold), t1.month, t2.month
from sales s, times t1, times t2
where s.order_date=t1.date and
s.ship_date=t2.date;

Example Query 2 has only a single query block, no additional sub-queries, but the query has two logical dimensions for table “times,” one for “t1” and one for “t2.” Both dimensions are the same except for the name. Accordingly, the query processor may transform the query to create re-use a data structure that is generated to process the times dimension. Such a transformation could be completed in one or two passes. In a two-pass approach, the transformation introduces, in a first pass, a first sub-query for “t1” and a second sub-query for “t2.” In a second pass, the query processor detects that the same data structure would be generated and used for both queries. Accordingly, the query processor adds a third sub-query to an outer query block. The third sub-query creates and saves the data structure for the times dimension. The query processor also transforms the first and second subqueries to reference the third sub-query.

### Generating Alternative Transformations

The query processor may generate alternative transformations based at least in part on a bank of available optimizations. The query processor may have a finite amount of time in which to attempt various query transformations and propose alternative transformations. Each transformation may be generated such that it is semantically equivalent to the received query or representation thereof, such as an execution plan. In other words, the received query or representation and the transformed query, if executed independently against the same data, would produce equivalent result sets, even if the result sets are assembled in different manners by the two queries. Similarly, the received query or representation and the newly generated execution plan, if executed independently against the same data, would produce equivalent result sets, even if the results sets are assembled in different manners by the two representations. Result sets are equivalent when they provide the data requested by a query or execution plan and represent the same data.

Semantically equivalent queries may have other byproducts besides the result sets, and these byproducts do not need to be the same or even similar. For example, execution of one query could cause creation and use of a data structure to produce a result set more efficiently, and execution of a semantically equivalent query might not create or use the data structure at all. In yet another example, a semantically equivalent query creates the data structure once and re-uses the data structure during query execution. The data structure may or may not persist after execution of the query.

During query analysis, the query processor may consider only the content of the query itself, only the query content in combination with other metadata received with the query, or the query content and other metadata, whether or not such metadata was received with the query. When analyzing the content of the query, the query processor may look at the syntax of the query, the database objects referenced by the query, the operations performed with respect to these objects alone, the join operations that connect multiple objects together, and/or the constraints placed on the objects.

In one embodiment, the query processor and/or execution engine may use pseudo-SQL during query transformation and/or query execution. The pseudo-SQL might not conform to standard SQL but may be recognized by particular query processors and particular execution engines. In other words, the pseudo-SQL may be vendor-specific. The pseudo-SQL syntax may include any syntax that is helpful for referencing the entities and operations involved in query execution, and the pseudo-SQL syntax may be processed internally without being exposed to the application or user and without affecting the accuracy of query results. In other words, the pseudo-SQL syntax may be semantically equivalent to the received query.

At some point in the transformation process, there may be a transformation for which there are no further available transformations. The query processor may construct a hierarchy of available transformations to be weighed against each other. At or before the expiration of that amount of time, the query processor selects one of the available transformations to perform on the query. The query processor may pass the alternative transformations to a costing mechanism to determine which of the alternative transformations is cheapest to execute. The selected transformation may be a single transformation or a combination of multiple transformations.

In one embodiment, the query processor generates a transformation that, if executed, would duplicate generation and use of at least part of a data structure. The query processor may also generate another transformation that, if executed, would re-use the at least part of the data structure rather than duplicate generation. The query processor may send both transformations or only a selected one of the transformations to the costing mechanism. For example, the query processor may exclude the transformation that duplicates generation upon determining that the other transformation is available.

The query processor may generate the transformations based at least in part on a set of conditions that are stored in association with available transformations. The available transformations may be applicable only when the conditions are met, and the available transformations may be ignored when the conditions are not met. In this embodiment, analyzing content of the query may include determining whether different sub-queries of the query satisfy the stored conditions, and the candidate transformations, including the selected transformation, may be generated for those sub-queries that do satisfy the stored conditions. For example, one available transformation may be based on whether or not the query includes any aggregation. If the query does not include any aggregation, the transformation is not applicable.

The query processor may or may not automatically generate a candidate transformation to re-use a data structure, even if possible. In one example, the query processor determines whether or not to generate such a candidate transformation based on how many times the data structure is re-used. In some examples, the query processor may avoid re-using the data structure unless it is used 2, 3, 4, or more times.

In one example, the query processor receives a query such as Query 3 below.

QUERY 3

SELECT sum(s.amount_sold), avg(s.amount_sold), cu.cust_state_province, co.country_name
FROM sales s, customers cu, countries co
WHERE s.cust_id=cu.cust_id
AND cu.country_id=co.country_id
GROUP BY cu.cust_state_province, co.country_name;

In the example, the query computes two aggregations: the sum of the amount_sold column of the sales table and the average of the amount_sold column of the sales table. In order to perform the sum calculation on the sales table, the query processor may generate a transformed query that, before looking at the sales table, first creates a data structure to store dense set identifiers that identify all value combinations that actually occur in the dimension that includes customers and countries. Then, the transformed query may use the data structure to map individual rows of the sales table to different containers that correspond to the different value combinations associated with the individual rows of the sales table. In the example, the query processor may use at least two structures to compute the sum of the amount_sold for the sales table, one for defining the dimension and one for holding data that is accumulated from the sales table.

Similarly, if the query processor were to separately compute the average of the amount_sold, the query processor may generate a transformed query that, before looking at the sales table, first creates a data structure to define unique values that occur in the grouped columns (cu.cust_state_province and co.country_name), also referred to as the dimensional data in this example. Then, the transformed query may use the data structure to map individual rows of the sales table to different containers that correspond to the different value combinations associated with the individual rows of the sales table. In the example, the query processor may use at least two structures to compute the average of the amount_sold for the sales table, one for defining the grouped data and one for holding data that is accumulated from the sales table.

In the example, instead of transforming the query to generate two separate data structures, the query processor may cause the average operation to re-use some or all of the data structures generated to compute the sum. In the example, the sum was computed for the same column as the average, and an average computation may involve first computing the sum and then dividing the sum by the number of entries.

In the example, the query processor could generate a transformed query that, when executed, would cause an execution engine to save the storage containers and the aggregated values stored in the containers. When computing the average, the execution engine, according to the transformed query, would access the storage containers that already have the aggregated data. In other words, the transformed query would not have to re-compute the sum in order to compute the average.

The query processor may also recognize that both aggregation operations require much of the same data, and, as a result, cause the data structure to hold not only the sum but also the number of entries that contributed to the sum. In this example, computation of the sum may take longer due to the storage, in the storage containers, of a count that keeps track of how many values contributed to the sum. However, upon re-using the data structure that holds the sum and the count, the average computation may be performed without even accessing the sales table. In the example, the query may be rewritten to first generate a data structure that holds the sum and count for each combination of values that occur in the grouping, and then, based on the data structure itself, retrieve the sum and compute the average.

If the count values are not stored in the data structure, the execution engine may re-access the fact table to count how many values are in each group. In this example, the execution engine would not have to re-compute the sum but may compute, for the first time, the number of values that contribute to that sum. To complete this computation, the query processor may instruct the execution engine to use the data structures that hold the dimensional data for the sales table. The execution engine may, based on the transformed query, retrieve these data structures from temporary storage without re-computing them. Then, the data structures are used to efficiently count the number of occurrences in each group. The average may then be computed by dividing the sum by the number of occurrences on a group-by-group basis.

Although the example relates to re-use of data structures that are generated based on data set identifiers, the techniques described herein are not limited to the re-use of such data structures. Any data structure that would be created to execute a query may be considered as a candidate for re-use. The query processor may analyze the query to determine, if the query was executed in different ways (i.e., according to different transformations or execution plans), which underlying data structures might have been generated more than once. Then, instead of generating these data structures more than once, the query is rewritten to first create and store the data structure and then reference the stored data structure.

In another example, the query processor receives a query such as Query 4 below.

QUERY 4

SELECT s.tx_id, cu.cust_id, s.date, s.amount
FROM sales s, customers cu
WHERE ((cu.cust_id, s.amount) IN (SELECT cu.cust_id, MIN(s.amount) FROM sales s
WHERE s.feedback=‘positive’ GROUP BY cu.cust_id)) AND ((cu.cust_id, s.date) IN
(SELECT cu.cust_id, MAX(s.date) FROM sales s WHERE s.bill_cycle=‘2’ GROUP BY cu.cust_id));

In the example, the query processor may enable reuse of data structures across different subqueries. The query processor may identify, based on the two GROUP BY operations, that a range of values will be computed twice for cu.cust_id. Accordingly, the query processor may rewrite the query to re-use information about the range of values that actually occur in cu.cust_id. The range of possible values in cu.cust_id may be computed once and used to compute both the MIN and MAX aggregation operations that appear in the query.

The range of values may be computed and saved in a separate sub-query that appears in the outer level of Query 4. In this example, the first sub-query (“SELECT cu.cust_id, MIN(s.amount) . . . ”) and the second sub-query (“SELECT cu.cust_id, MAX(s.date) . . . ”) may be rewritten to reference the separate sub-query that is executed first in the outer level of Query 4. In another example, the range of values may be computed upon computing the first sub-query (“SELECT cu.cust_id, MIN(s.amount) . . . ”) as long as the first sub-query is marked to be executed before the second sub-query.

In the example, the two matching sub-queries return different rows, but both sub-queries return a subset of a third subquery, where the filters are moved into CASE expressions inside the MIN(s.amount) and MAX(s.date) aggregations. Results from the third sub-query may be stored in an internal, intermediate data structure, and then the query processor would choose the aggregation appropriate to the reference for each of the two references to that data structure. In another embodiment, the query processor looks only for isomorphic sub-queries.

Also in the example, the different sub-queries are nested within the same outer query. In other examples, the different sub-queries may be even further separated, and may not even be on the same level in the query hierarchy. For example, one query may be nested within a child of a grandparent query, and another query may be nested within a child of a different child of the grandparent query.

### Cost-Based Transformation

The costing mechanism may estimate the cost of executing the query based at least in part on: size(s) of table(s) referenced by the query, as indicated by metadata stored about the table(s), larger tables generally taking longer to process; type(s) of accesses (such as read or write) that would be performed by different query operations, a write generally costing more than a read; whether any of the data is indexes or has an available materialized view, such data generally being processed more quickly; the device(s) from which the data would have to be retrieved, where data retrieved from devices with longer response times or lag may cost more; and/or the amount of memory and/or processor cycles that would be required to complete operations in the transformation, where transformations that use less memory and consume fewer processor cycles are generally cheaper.

The query processor may generate an execution plan or transformed query or select a generated execution plan or transformed query based at least in part on an estimated execution cost for the execution plan or transformed query. For example, a candidate query may be generated or selected for execution upon determining that the candidate query is expected to save a threshold amount of time or computing resources or upon determining that the candidate query is expected to use less time or computing resources than other candidate queries.

The costing mechanism may also account for the order of access of different structures in the query. For example, optimizations may be available for efficiently processing dimension tables before fact tables. A candidate query may be generated or selected for execution upon determining that the candidate query uses, as its candidate fact table, a table above a threshold size or a table that is larger than other tables referenced by the query. In another example, a candidate query may be selected from among a plurality of candidate queries upon determining that the candidate query uses, as its candidate fact table, a table that is larger than the candidate fact tables in the other candidate queries. Alternatively, the candidate query may be generated or selected upon determining that the candidate query uses, as its candidate dimension table(s), table(s) that are smaller than candidate dimension tales in other candidate queries.

In one embodiment, even if the query processor generates a particular transformation that, if executed, could re-use at least part of a data structure, the query processor may also send, to the costing mechanism, another transformation that duplicates generation of the at least part of the data structure. The other transformation may actually be cheaper than the particular transformation in certain scenarios. For example, if the data structure is inexpensive to generate and the server has little memory available to retain the data structure, then the costing mechanism may actually select the other transformation rather than the particular transformation, even though the other transformation involves duplicated effort.

In one example, the costing mechanism or the query processor separately weighs the cost of generating the data structure rather than considering the particular transformation and the other transformation separately in their entirety. In the example, the costing mechanism may select the particular transformation based at least in part on determining that generation of the data structure involves a threshold amount of analytical processing. For example, generation of the data structure may involve a complex operation such as aggregation, and the query processor may predict that the benefit of preventing duplication of the complex operation outweighs the cost of retaining the data structure.

### Query Execution

After the query or representation has been transformed, the query processor may cause the query to be executed using the transformation. For example, the query processor may send the transformed query or representation to an execution engine, and the execution engine may execute the query against a database. Upon execution, the execution engine creates and re-uses at least part of a data structure to generate a result set. The result set may then be returned to an application or user that submitted the query to a server system comprising the query processor and the execution engine.

In one example, the server may receive a transformed query or representation that aggregates data from fact table(s) and references dimension table(s). Based on a first part of the transformed query or representation, the server may determine set identifiers that identify different combinations of values that occur in a set of column(s) of the dimension table(s). These set identifiers may be stored in data structures. Further, based on the set identifiers, the server may create another data structure comprising different storage containers for each different set of value(s) that occur in the set of column(s). The different storage containers are mapped to different rows of the dimension table(s). The server may then evaluate the first part of the query or representation to aggregate data from the fact table(s) at least in part by using keys in the fact table(s) to locate corresponding storage containers of the different storage containers. The server may, as instructed by the first part of the query or representation, store the data structures, including the set identifier(s) themselves and/or the aggregated data, in temporary or persistent storage for use by a second part of the query.

Based on a second part of the transformed query or representation, the server may retrieve data from the data structures and/or store more data into the data structures that were generated by the first part of the query. For example, the second part of the query may reference one or more of the dimensions that were used in the first part of the query, and the second part of the query may re-use the set identifiers that were already determined for the referenced dimension(s). As another example, the second part of the query may reference at least part of the aggregation that was computed by the first part of the query, and the second part of the query may re-use the storage containers that were computed by the first part of the query. The first part of the query may have assigned a name or location to the data structure(s) that were created by the first part of the query, and the second part of the transformed query or representation may have been modified to reference the data structure(s) that were created by the first part of the query.

Example aggregation operations include, but are not limited to, sums, maximums, and minimums. In each of these examples, a storage container holds a rolling aggregate value that is initialized to zero or null and is aggregated iteratively as new data is placed into the storage container. Other aggregation operations, such as averages, are also possible. For example, an average could be computed using the storage containers to hold a tuple comprising a rolling sum and a rolling number of rows that contributed to the rolling sum. Once the server is finished filling the storage containers, the average may be computed by dividing the rolling sum by the rolling number of rows.

In one embodiment, the query processor transforms the query to cause the execution engine to delete the re-used data structure after a last sub-query or sub-operation has finished using the data structure. In another embodiment, the data structure is moved from a temporary table to a results cache after the query is executed. In yet another embodiment, the execution engine retains the temporary data structure in temporary storage or in the results cache even after the query has finished executing.

### Extensions and Alternatives

Various examples herein refer to receiving, processing or analyzing a query. As used herein, a query may refer to individual query blocks, which are separately consumable chunks of query language. Query blocks are processed to provide separate sets of results, but result sets from multiple query blocks could be combined to form another set of results. In other words, separate queries, as referred to herein, may actually be separately consumable sub-queries of a higher-level query.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

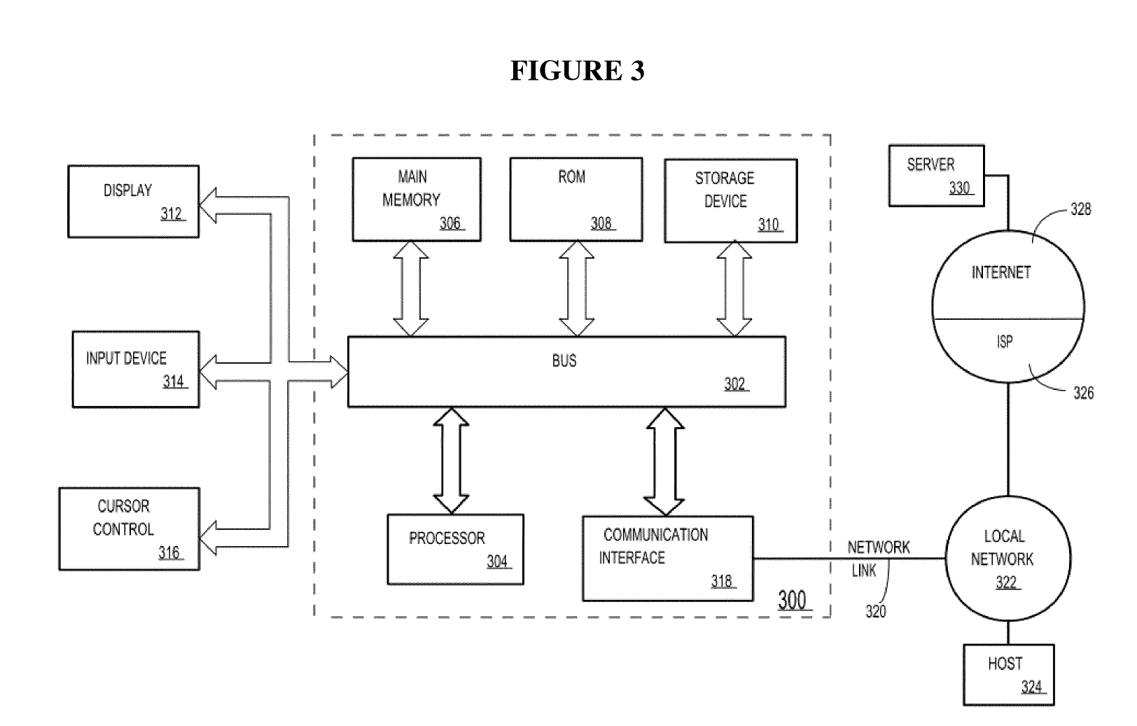

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a query;
before executing the query, analyzing content of the query to determine whether the query contains two or more sub-queries that, if executed, could cause generation of at least part of a data structure;
based at least in part on determining that the query contains the two or more sub-queries, transforming the query to a transformed query comprising:
a first transformed sub-query that, when executed, creates and stores the at least part of the data structure, and
at least a second transformed sub-query that, when executed, uses the at least part of the data structure stored by the first transformed sub-query;
wherein the method is performed by one or more computing devices.

2. The method of claim 1, wherein the first transformed sub-query, when executed, causes generation of the at least part of the data structure at least in part by determining set identifiers that identify unique combinations of values that occur in two or more dimension columns referenced by at least the first sub-query.

3. The method of claim 1, wherein the first transformed sub-query, when executed, causes generation of the at least part of the data structure at least in part by aggregating values from one or more database objects referenced by at least the first sub-query.

4. The method of claim 1, further comprising creating and re-using the at least part of the data structure at least in part by executing the transformed query.

5. The method of claim 1, further comprising determining that generation of the at least part of the data structure involves a threshold amount of analytical processing; wherein transforming the query to the transformed query is also based at least in part on determining that generation of the at least part of the data structure involves the threshold amount of analytical processing.

6. The method of claim 1, wherein analyzing the content of the query comprises determining whether different sub-queries of the query satisfy stored conditions stored in association with candidate transformations; wherein transforming the query to the transformed query is also based at least in part on determining that at least two of the different sub-queries satisfy one or more of the stored conditions.

7. The method of claim 1, wherein the first transformed sub-query, when executed, causes the at least part of the data structure to be stored separately from a results cache that is used during execution of the query to cache results for the query, and wherein the at least part of the data structure is retained in storage until after the at least part of the data structure has been used for at least the second transformed sub-query.

8. The method of claim 1, wherein the at least part of the data structure is not referenced by the received query and would not have been generated by the received query without transformation; wherein the first sub-query comprises a complex operation for which a candidate transformation creates and uses the at least part of the data structure, and wherein the second sub-query comprises the complex operation.

9. A method comprising:
receiving a representation of a query;
before executing the representation, analyzing the representation to determine whether the representation, if executed, could cause two or more sub-operations to generate at least part of a data structure;
based at least in part on determining that the representation contains the two or more operations, transforming the representation into a transformed representation that, when performed, causes
a first transformed sub-operation that creates and stores the at least part of the data structure, and
at least a second transformed sub-operation that uses the at least part of the data structure stored by the first transformed sub-operation;
wherein the method is performed by one or more computing devices.

10. The method of claim 9, wherein the first transformed sub-operation, when performed, causes generation of the at least part of the data structure at least in part by determining set identifiers that identify unique combinations of values that occur in two or more dimension columns on which the first sub-operation operates.

11. The method of claim 9, wherein the first transformed sub-operation, when performed, causes generation of the at least part of the data structure at least in part by aggregating values from one or more database objects into the at least part of the data structure.

12. The method of claim 9, further comprising creating and re-using the at least part of the data structure at least in part by performing the transformed representation, wherein the transformed representation is an execution plan.

13. The method of claim 9, wherein the at least part of the data structure is not referenced by the received representation and would not have been generated by the received representation without transformation; wherein the first sub-operation comprises a complex operation for which a candidate transformation creates and uses the at least part of the data structure, and wherein the second sub-operation comprises the complex operation.

14. One or more non-transitory computer-readable storage media storing instructions which, when executed, cause:
storing a query;
before executing the query, analyzing content of the query to determine whether the query contains two or more sub-queries that, if executed, could cause generation of at least part of a data structure;
based at least in part on determining that the query contains the two or more sub-queries, transforming the query to a transformed query comprising:
a first transformed sub-query that, when executed, creates and stores the at least part of the data structure, and
at least a second transformed sub-query that, when executed, uses the at least part of the data structure stored by the first transformed sub-query.

15. The one or more non-transitory computer-readable storage media of claim 14, wherein the first transformed sub-query, when executed, causes generation of the at least part of the data structure at least in part by determining set identifiers that identify unique combinations of values that occur in two or more dimension columns referenced by at least the first sub-query.

16. The one or more non-transitory computer-readable storage media of claim 14, wherein the first transformed sub-query, when executed, causes generation of the at least part of the data structure at least in part by aggregating values from one or more database objects referenced by at least the first sub-query.

17. The one or more non-transitory computer-readable storage media of claim 14, further comprising creating and re-using the at least part of the data structure at least in part by executing the transformed query.

18. The one or more non-transitory computer-readable storage media of claim 14, further comprising determining that generation of the at least part of the data structure involves a threshold amount of analytical processing; wherein transforming the query to the transformed query is also based at least in part on determining that generation of the at least part of the data structure involves the threshold amount of analytical processing.

19. The one or more non-transitory computer-readable storage media of claim 14, wherein analyzing the content of the query comprises determining whether different sub-queries of the query satisfy stored conditions stored in association with candidate transformations; wherein transforming the query to the transformed query is also based at least in part on determining that at least two of the different sub-queries satisfy one or more of the stored conditions.

20. The one or more non-transitory computer-readable storage media of claim 14, wherein the first transformed sub-query, when executed, causes the at least part of the data structure to be stored separately from a results cache that is used during execution of the query to cache results for the query, and wherein the at least part of the data structure is retained in storage until after the at least part of the data structure has been used for at least the second transformed sub-query.

21. The one or more non-transitory computer-readable storage media of claim 14, wherein the at least part of the data structure is not referenced by the received query and would not have been generated by the received query without transformation; wherein the first sub-query comprises a complex operation for which a candidate transformation creates and uses the at least part of the data structure, and wherein the second sub-query comprises the complex operation.

22. One or more non-transitory computer-readable storage media storing instructions which, when executed, cause:
receiving a representation of a query;
before executing the representation, analyzing the representation to determine whether the representation, if executed, could cause two or more sub-operations to generate at least part of a data structure;
based at least in part on determining that the representation contains the two or more operations, transforming the representation into a transformed representation that, when performed, causes
a first transformed sub-operation that creates and stores the at least part of the data structure, and
at least a second transformed sub-operation that uses the at least part of the data structure stored by the first transformed sub-operation.

23. The one or more non-transitory computer-readable storage media of claim 22, wherein the first transformed sub-operation, when performed, causes generation of the at least part of the data structure at least in part by determining set identifiers that identify unique combinations of values that occur in two or more dimension columns on which the first sub-operation operates.

24. The one or more non-transitory computer-readable storage media of claim 22, wherein the first transformed sub-operation, when performed, causes generation of the at least part of the data structure at least in part by aggregating values from one or more database objects into the at least part of the data structure.

25. The one or more non-transitory computer-readable storage media of claim 22, further comprising creating and re-using the at least part of the data structure at least in part by performing the transformed representation, wherein the transformed representation is an execution plan.

26. The one or more non-transitory computer-readable storage media of claim 22, wherein the at least part of the data structure is not referenced by the received representation and would not have been generated by the received representation without transformation; wherein the first sub-operation comprises a complex operation for which a candidate transformation creates and uses the at least part of the data structure, and wherein the second sub-operation comprises the complex operation.
